(19) United States
(12) Patent Application Publication
(10) Pub. No.: US 2024/0222665 A1
(43) Pub. Date: Jul. 4, 2024

(54) SYSTEM AND METHOD FOR THERMAL MANAGEMENT OF ELECTRIC PARTS

(71) Applicant: HYUNDAI MOBIS CO., LTD., Seoul (KR)

(72) Inventor: Yong Hee LEE, Yongin-si (KR)

(73) Assignee: HYUNDAI MOBIS CO., LTD., Seoul (KR)

(21) Appl. No.: 18/535,316

(22) Filed: Dec. 11, 2023

(30) Foreign Application Priority Data
Jan. 4, 2023 (KR) 10-2023-0001232

(51) Int. Cl. H01M 8/0432; H01M 8/04007; H01M 8/04029; H01M 8/04701; H01M 8/04746

(52) U.S. Cl. CPC H01M 8/04373; H01M 8/04029; H01M 8/04067; H01M 8/04358; H01M 8/04723; H01M 8/04738; H01M 8/04768

(57) ABSTRACT

A system and method for thermal management of electric parts are provided. The system includes a first cooling line in which a first cooling fluid is circulated, a second cooling line in which a second cooling fluid is circulated, a valve to selectively pass a first cooling fluid or a second cooling fluid via a first type electric part, and a controller to control the valve based on information corresponding to the first type electric part.

### CROSS-REFERENCE TO RELATED APPLICATION

This application claims the benefit of priority to Korean Patent Application No. 10-2023-0001232, filed in the Korean Intellectual Property Office on Jan. 4, 2023, the entire contents of which are incorporated herein by reference.

### BACKGROUND

### 1. Field

Embodiments disclosed in the present disclosure relate to a system and a method for thermal management of electric parts.

### 2. Description of Related Art

A fuel cell system may produce electrical energy by using a fuel cell stack. For example, when hydrogen is used as a fuel of the fuel cell stack, it may be a measure for solving an environment problem of the earth, and thus fuel cell systems have been continuously researched and developed. The fuel cell system may include a fuel cell stack that produces electric energy, a fuel supply device that supplies a fuel (hydrogen) to the fuel cell stack, an air supply device that supplies oxygen in air, which is an oxidizer that is necessary for an electrochemical reaction, to the fuel cell stack, and a thermal management system (TMS) that removes heat of reaction of the fuel cell stack to an outside, controls an operation temperature of the fuel cell stack, and perform a water managing function.

The thermal management system is a kind of cooling device that maintain a specific temperature (for example, 60 to 70 degrees Celsius) by circulating an anti-freezer solution that functions as a cooling fluid to the fuel cell stack, and may include a TMS line, in which the cooling fluid is circulated, a reservoir, in which the cooling fluid is stored, a pump that circulates the cooling fluid, an ion filter that removes ions contained in the cooling fluid, and a radiator that discharges heat of the cooling fluid to an outside. Furthermore, the thermal management system may include a heater that heats the cooling fluid, and an air conditioning unit (for example, a heater for heating) that cools and heats an interior of a device (e.g., a vehicle) including the fuel cell system by using the cooling fluid. The thermal management system may maintain electric parts of the vehicle as well as the fuel cell stack at proper temperatures.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In a general aspect of the disclosure, a system for thermal management of electric parts, the system includes: a first cooling line, in which a first cooling fluid is circulated; a second cooling line, in which a second cooling fluid is circulated; a valve configured to selectively pass a first cooling fluid or a second cooling fluid via a first type electric part; and a controller connected to the valve, wherein the controller is configured to control the valve based on information corresponding to the first type electric part.

The controller may be further configured to control the valve based on pulse width modulation switching frequency information and reference frequency information when a pulse width modulation switching frequency information is acquired as the information corresponding to the first type electric part.

The reference frequency information may include first reference frequency information and second reference frequency information, and the controller may be further configured to: determine, among the first reference frequency information and the second reference frequency information, specific reference frequency information corresponding to the pulse width modulation switching frequency information; and control the valve based on the specific reference frequency information.

The system may further include: a first pump disposed on the first cooling line and configured to pump the first cooling fluid; a second pump disposed on the second cooling line and configured to pump the second cooling fluid; and a radiator disposed on the first cooling line and the second cooling line and configured to cool the first cooling fluid and the second cooling fluid.

The radiator may include a first radiator configured to cool the first cooling fluid, and a second radiator configured to cool the second cooling fluid.

The system may further include a cooling fan configured to blow exterior air to the radiator.

The cooling fan may include a first cooling fan configured to blow the exterior air to the first radiator, and a second cooling fan configured to blow the exterior air to the second radiator.

The system may further include a second type electric part, via which the first cooling fluid in the first cooling line passes, and the controller may be further configured to control the valve based on information corresponding to the second type electric part.

The controller may be further configured to control the first cooling fan and the first pump such that a revolutions-per-minute (RPM) of the first cooling fan and an RPM of the first pump are proportional to an output value of a fuel cell stack, and the fuel cell stack may be configured to interwork with the first type electric part and the second type electric part.

The controller may be further configured to: control the second cooling fan such that an RPM of the second cooling fan comprises a first threshold RPM or an RPM greater than the first threshold RPM; and control the second pump such that an RPM of the second pump is a second threshold RPM or an RPM greater than the second threshold RPM when determining that a temperature of the second cooling fluid is a threshold temperature or a temperature higher than the threshold temperature.

The controller may be further configured to control the second cooling fan and the second pump such that an RPM of the second cooling fan and an RPM of the second pump is proportional to an output value of a fuel cell stack, and the fuel cell stack may be configured to interwork with the first type electric part and the second type electric part, when a temperature of the second cooling fluid is lower than a threshold value.

In another general aspect of the disclosure, a method for thermal management of electric parts, the method includes: acquiring information corresponding to a first type electric part; selecting a specific cooling line among a first cooling line in which a first cooling fluid is circulated, and a second cooling line in which a second cooling fluid is circulated, based on the information corresponding to the first type electric part; and controlling a valve such that the cooling fluid in the selected specific cooling line passes via the first type electric part.

The specific cooling line may include determining the specific cooling line based on pulse width modulation switching frequency information of the first type electric part, the pulse width modulation switching frequency information comprising information corresponding to the first type electric part and reference frequency information.

The reference frequency information may include first reference frequency information and second reference frequency information, and the method may further include: determining among the first reference frequency information and the second reference frequency information, specific reference frequency information corresponding to the pulse width modulation switching frequency information of the first type electric part; and determining the specific cooling line based on the specific reference frequency information.

The method may further include: controlling a first cooling fan and a first pump such that a revolutions-per-minute (RPM) of the first cooling fan configured to blow exterior air to a first radiator that cools the first cooling fluid and an RPM of the first pump configured to pump the first cooling fluid are proportional to an output value of a fuel cell stack; and the fuel cell stack may be configured to interwork with the first type electric part and a second type electric part, via which the first cooling fluid passes.

The method may further include: controlling a second cooling fan such that an RPM of the second cooling fan configured to blow the exterior air to a second radiator that cools the second cooling fluid is a first threshold RPM or an RPM greater than the first threshold RPM; and controlling a second pump such that an RPM of the second pump configured to pump the second cooling fluid is a second threshold RPM or an RPM greater than the second threshold RPM when determining that a temperature of the second cooling fluid is a threshold temperature or higher than the threshold temperature.

The method may further include: controlling a second cooling fan and the second pump such that an RPM of the second cooling fan configured to blow the exterior air to a second radiator that cools the second cooling fluid and an RPM of a second pump configured to pump the second cooling fluid are proportional to an output value of a fuel cell stack, and the fuel cell stack may be configured to interwork with the first type electric part, when determining that a temperature of the second cooling fluid is lower than a threshold temperature.

The information corresponding to the first type electric part may include an optimal operation temperature for the first type electric part.

The information corresponding to the second type electric part may include an optimal operation temperature for the second type electric part.

### BRIEF DESCRIPTION OF THE DRAWINGS

The above and other objects, features and advantages of the present disclosure will be more apparent from the following detailed description taken in conjunction with the accompanying drawings:

FIGS. 1A and 1B illustrate conventional or related systems for thermal management of electric parts;

FIG. 2 illustrates a system for thermal management of electric parts according to an embodiment disclosed in the present disclosure;

FIG. 3 is a view illustrating an example of a radiator and a cooling fan included in a system for thermal management of electric parts according to an embodiment disclosed in the present disclosure;

FIG. 4 is a functional block diagram of a system for thermal management of electric parts according to an embodiment disclosed in the present disclosure; and

FIG. 5 is a flowchart of an operation of a system for thermal management of electric parts according to an embodiment disclosed in the present disclosure.

In relation to a description of the drawings, the same or similar components are denoted by the same or similar reference numerals.

### DETAILED DESCRIPTION

Hereinafter, various embodiments of the present disclosure will be described with reference to the accompanying drawings. Accordingly, those of ordinary skill in the art will recognize that modifications, equivalents, and/or alternatives on the various embodiments described herein can be variously made without departing from the scope and spirit of the present disclosure.

In the present disclosure, it is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “1st” and “2nd” or “first” and “second” may be used to simply distinguish a corresponding component from another, and does not limit the components in other aspects (e.g., an importance or an order). When it is mentioned that a certain (e.g., a first) component is “coupled to” or “connected to” another (e.g., a second) component together with or without a term of “functionally” or “communicatively”, it means that the former component may be connected to the latter component through a third component, directly (e.g., by wire) or wirelessly.

The components (e.g., modules or programs) described in the present disclosure may include a singular or a plurality of entities. According to various embodiments, among the components, one or more components or operations may be omitted or one or more other components or operations may be added. Alternatively or additionally, the plurality of components (e.g., modules or programs) may be integrated into one component. In this case, the integrated components may perform one or more functions of the plurality of components in a way that is the same as or similar to that performed by the corresponding ones of the plurality of components before the integration. According to various embodiments, the operations performed by modules, programs, or other components may be executed sequentially, in parallel, repeatedly, or heuristically, one or more operations may be executed in another sequence or omitted, or one or more other operations may be added.

The term “module” or “part” used in the present disclosure may include a unit configured in a hardware, software, or firmware way, and for example, may be used interchangeably with the terms such as logic, a logic block, a component, or a circuit. The module may be an integral part, or a minimum unit or a portion which performs one or more functions. For example, according to an embodiment, the module may be implemented in a form of an application-specific integrated circuit (ASIC).

Various embodiments of the present disclosure may be implemented by software (e.g., a program or an application) including one or more instructions stored in a storage medium (e.g., a memory) that may be read by a machine. For example, a processor of a device may call, among one or more instructions stored in a storage medium, at least one instruction, and may execute the instruction. This allows at least one function to be performed according to the called at least one instruction. The one or more instructions may include a code that is made by a compiler or a code that may be executed by an interpreter. The storage medium that may be read by a device may be provided in a form of a non-transitory storage medium. Here, the ‘non-transitory storage medium’ means that the storage medium is a tangible device and does not include a signal (e.g., an electromagnetic wave), and with regard to the term, a case, in which data are semi-permanently stored in the storage medium, and a case, in which data are temporarily stored in the storage medium, are not distinguished.

In an embodiment, a plurality of electric parts may be mounted on a vehicle, a construction machine, a flying object, and the like, and the electric parts may be largely classified into control devices and single products. The control devices, as an example, may include an inverter, a blower pump control unit (BPCU), a bi-directional high-voltage DC-DC converter (BHDC), and a low-voltage DC-DC converter (LDC), and the single products, for example, may include a traction motor, an air compressor, and an air cooler.

Among them, heat loss of the single products may decrease as temperature becomes lower regardless of the kinds thereof whereby their efficiencies increase, and temperatures of the control devices, at which optimum efficiencies thereof are exhibited, may be different according to the kinds of the switching elements.

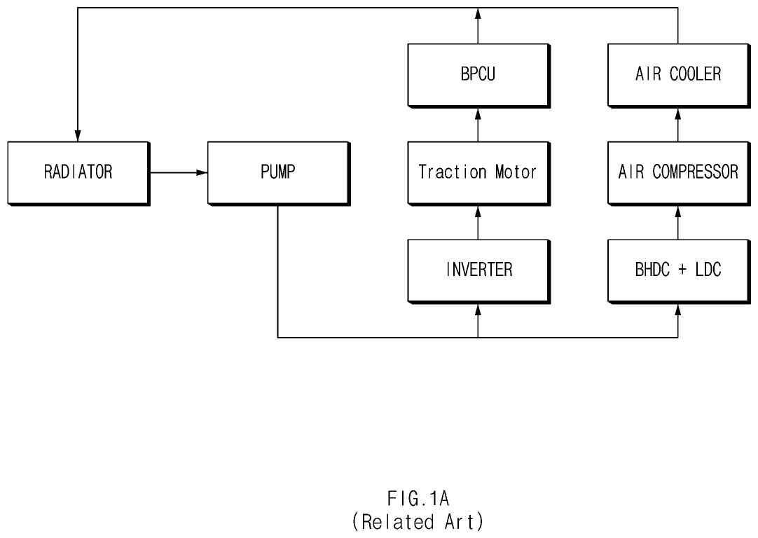

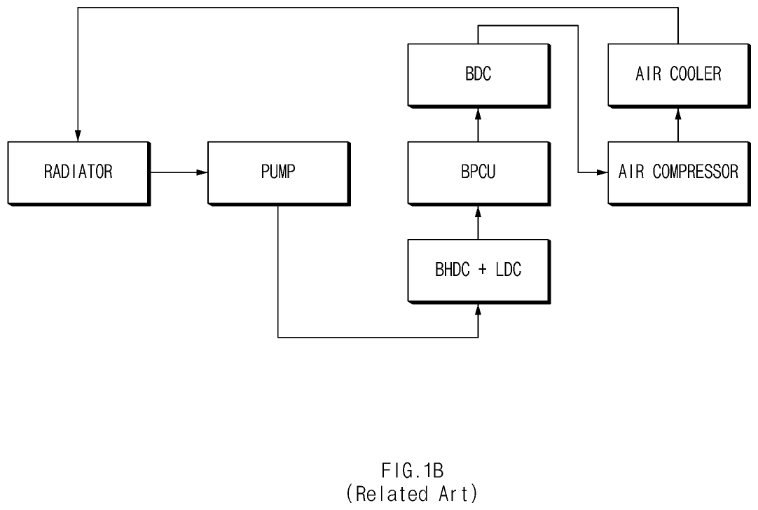

FIG. 1A schematically illustrates a conventional or related vehicular system for thermal management of electric parts and FIG. 1B schematically illustrates a conventional or related non-vehicular system for thermal management of electric parts. With reference to FIGS. 1A and 1B, it may be identified that conventional or related electric parts are cooled through one closed loop passage regardless of the kinds of the electric parts.

However, when cooling is performed through one closed loop passage in this way, all the electric parts are cooled at similar temperatures regardless of the kinds of the electric parts whereby efficiencies of the control devices decrease.

The technical problems to be solved by the present disclosure are not limited to the aforementioned problems, and any other technical problems not mentioned herein will be clearly understood from the following description by those skilled in the art to which the present disclosure pertains.

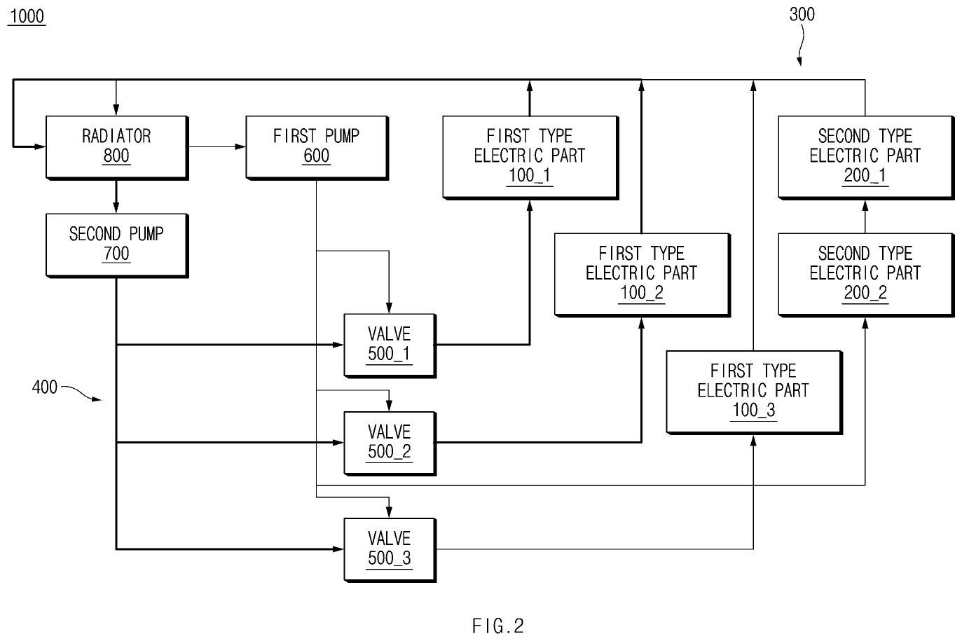

FIG. 2 illustrates a system for thermal management of electric parts according to an embodiment disclosed in the present disclosure.

Referring to FIG. 2, a system 1000 for thermal management of electric parts may include a first cooling line 300, in which the first cooling fluid is circulated, a second cooling line 400, in which a second cooling fluid is circulated, valves 500_1, 500_2, and 500_3 that are configured such that a specific fluid in a specific cooling line that is any one of the first cooling line 300 and the second cooling line 400 passes via first type electric parts 100_1, 100_2, and 100_3, and a controller (e.g., a processor).

A fuel cell stack (or may be referenced as a ‘fuel stack’) may have a structure that may produce electricity through an oxidation/reduction reaction of a fuel (for example, hydrogen) and an oxidizer (for example, air).

As an example, the fuel cell stack may include a membrane electrode assembly (MEA), in which catalyst electrode layers, in which an electrochemical reaction occurs, are attached on opposite sides of an electrode membrane, through which hydrogen ions travel, a gas diffusion layer (GDL) that functions to uniformly distribute reaction gases and deliver electrical energy thus generated, a gasket and a coupling tool for maintaining a sealing performance between the reaction gases and a proper coupling pressure, and a bipolar plate, through which the reaction gases and cooling fluid flow.

In the fuel cell stack, hydrogen that is a fuel and air (oxygen) that is an oxidizer may be supplied to an anode and a cathode of the membrane electrode assembly through passages of the bipolar plate, and for example, hydrogen may be supplied to the anode that is a hydrogen electrode and the air may be supplied to a cathode that is an air electrode.

The hydrogen supplied to the anode is decomposed to protons and electrons by catalysts of the electrode layers on opposite sides of an electrolyte membrane, and among them, only the hydrogen ions may be delivered to the cathode after selectively passing through the electrolyte membrane that is a positive ion exchange membrane, and the electrons may be delivered to the cathode through the gas diffusion layer and the bipolar plate that are conductors. In the cathode, the hydrogen ions supplied through the electrolyte membrane and the electrons delivered through the bipolar plate may generate a reaction of producing water while meeting oxygen in the air supplied to the cathode by an air supply apparatus. Due to flows of the hydrogen ions, which occur then, the electrons flow through an external wire, and currents may be generated due to the flows of the electrons.

Furthermore, a first pump 600 that is configured to pump a first cooling fluid may be disposed on the first cooling line 300, a second pump 700 that is configured to pump a second cooling fluid may be disposed on the second cooling line 400, and a radiator 800 that is configured to cool the first cooling fluid and the second cooling fluid and a cooling fan (not illustrated) that is configured to blow exterior air to the radiator 800 may be disposed on the first cooling line 300 and the second cooling line 400.

Furthermore, the controller may be connected to the valves 500_1, 500_2, and 500_3 to control operations thereof, and for example, may make a specific cooling fluid in, among the first cooling line 300 and the second cooling line 400, a specific cooling line, pass via the first type electric parts 100_1, 100_2, and 100_3 by controlling the valves 500_1, 500_2, and 500_3 based on information corresponding to the first type electric parts 100_1, 100_2, and 100_3.

Referring to FIG. 2, it may be identified that three valves 500_1, 500_2, and 500_3 are illustrated. In detail, it may be identified that the first valve 500_1 may be located between an outlet of the first pump 600 and an outlet of the second pump 700, and the first type electric part 100_1, the second valve 500_2 may be located between the outlet of the first pump 600 and the outlet of the second pump 700, and the first type electric part 100_2, and the third valve 500_3 may be located between the outlet of the first pump 600 and the outlet of the second pump 700, and the first type electric part 100_3.

Here, an inlet of the first pump 600 may be defined as an inlet, through which the first cooling fluid is introduced into the first pump 600. Furthermore, the outlet of the first pump 600 may defined as an outlet, through which the first cooling fluid that passed through the first pump 600 is discharged. The first pump 600 may be configured to cause the first cooling fluid to compulsorily flow. The first pump 600 may include various means that may pump the first cooling fluid, and the kind, the number, and the characteristics of the first pump 600 are not limited in the present disclosure.

Furthermore, an inlet of the second pump 700 may be defined as an inlet, through which the second cooling fluid is introduced into the second pump 700. Furthermore, the outlet of the second pump 700 may defined as an outlet, through which the second cooling fluid that passed through the second pump 700 is discharged. The second pump 700 may be configured to cause the second cooling fluid to compulsorily flow. The second pump 700 may include various means that may pump the second cooling fluid, and the kind, the number, and the characteristics of the second pump 700 are not limited in the present disclosure.

Furthermore, the valves 500_1, 500_2, and 500_3 may include various valve means that may selectively switch flow paths of the cooling fluids. As an example, the valves may be three way valves.

For example, each of the valves 500_1, 500_2, and 500_3 may include a first port that is connected to the first cooling line 300 such that the first cooling fluid pumped by the first pump 600 is introduced therethrough, a second port that is connected to the second cooling line 400 such that the second cooling fluid pumped by the second pump 700 is introduced therethrough, and a third port that is connected to ends of the first type electric parts 100_1, 100_2, and 100_3.

The cooling fluid in any one of the first cooling line 300 and the second cooling line 400 may be introduced as the first port and the second port of the valve 500_1 is opened. That is, when the first port and the third port are opened and the second port is closed, the first cooling fluid in the first cooling line 300 may be introduced into the first type electric parts 100_1, 100_2, and 100_3, and unlike this, when the second port and the third port are opened and the first port is closed, the second cooling fluid in the second cooling line 400 may be introduced into the first type electric parts 100_1, 100_2, and 100_3.

For reference, FIG. 2 illustrates a state, in which the second cooling fluid in the second cooling line 400 is introduced into the first type electric part 100_1 as the second port and the third port of the first valve 500_1 are opened, the second cooling fluid in the second cooling line 400 is introduced into the first type electric part 100_2 as the second port and the third port of the second valve 500_2 are opened, and the first cooling fluid in the first cooling line 300 is introduced into the first type electric part 100_3 as the first port and the third port of the third valve 500_3 are opened.

Meanwhile, the electric parts of the vehicle may be understood as parts that use electric power of the vehicle as energy sources thereof, and the present disclosure is neither limited nor restricted by the kinds and the number of the electric parts. As an example, the electric parts may include at least any one of a bi-directional high-voltage DC-DC converter (BHDC) that is provided between the fuel cell stack and a high-voltage battery (not illustrated) of the vehicle, a blower pump control unit (BPCU) that supplies exterior air for driving the fuel cell stack, a low-voltage DC-DC converter (LDC) that converts a DC high voltage supplied from the high-voltage battery to a DC low voltage, an air compressor (ACP) that compresses the air supplied to the fuel cell stack, and an air cooler. In addition, the electric parts may further include a DC-DC buck/boost converter.

The electric parts may include the first type electric parts 100_1, 100_2, and 100_3 and second type electric parts 200_1 and 200_2, and unlike the second type electric parts 200_1 and 200_2 that will be described below, temperature sections of the first type electric parts 100_1, 100_2, and 100_3, in which optimum efficiencies are exhibited, may be different according to the kinds thereof. For example, among switching elements SiC, GaN, and IGBT included in the first type electric parts 100_1, 100_2, and 100_3, SiC and GaN may show optimum efficiencies at around 25 degrees Celsius, whereas IGBT may show an optimum efficiency at around 40 degrees Celsius.

In this way, temperature sections of the first type electric parts 100_1, 100_2, and 100_3, in which optimum efficiencies are shown, are different according to the kinds thereof, and according to the system 1000 for thermal management of electric parts of the present disclosure, the efficiencies of the electric parts may be maximized by performing a control such that optimum cooling lines for the kinds of the first type electric parts 100_1, 100_2, and 100_3 pass via the electric parts.

Meanwhile, information corresponding to the first type electric parts is a pulse width modulation switching frequency information of the first type electric parts, and for example, may be pulse width modulation switching frequency information of the switching elements of the first type electric parts.

As an example, when acquiring the pulse width modulation switching frequency information of the first type electric parts as information corresponding to the first type electric parts, the controller may make a specific cooling fluid in, among the first cooling line 300 and the second cooling line 400, a specific cooling line pass via the first type electric parts 100_1, 100_2, and 100_3, by controlling the valves 500_1, 500_2, and 500_3 based on the reference frequency information and the acquired pulse width modulation switching frequency information.

Then, the reference frequency information may include a plurality of reference frequency information (for example, first reference frequency information and second reference frequency information), and the controller may determine, among the first reference frequency information and the second reference frequency information, specific reference frequency information corresponding to the pulse width modulation switching frequency information of the first type electric parts 100_1, 100_2, and 100_3, and may control the valves 500_1, 500_2, and 500_3 such that a specific cooling fluid in, among the first cooling line 300 and the second cooling line 400, a specific cooling line passes via the first type electric parts 100_1, 100_2, and 100_3, based on the specific reference frequency information.

As an example, it is assumed that the first reference frequency information (for example, information of a frequency band of 100 KHz or more) is set to correspond to the switching element GaN, the second reference frequency information (for example, information of a frequency band of more than 20 KHz and less than 100 kHz) is set to correspond to the switching element SIC, the third reference frequency information (for example, information of a frequency band of less than 20 kHz) is set to correspond to the switching element IGBT, the first cooling line 300 is set to correspond to the third reference frequency information, and the second cooling line 400 is set to correspond to the first reference frequency information and the second reference frequency information.

Then, when the pulse width modulation switching frequency information acquired from the first type electric parts 100_1 illustrated in FIG. 2 is 40 kHz (that is, when the switching element included in the first type electric parts 100_1 is SiC), the controller may determine, among the first to third reference frequency information, the second reference frequency information (that is, information of a frequency band of not less than 20 KHz and less than 100 kHz) corresponding to the pulse width modulation switching frequency information of 40 KHz as specific reference frequency information, and may control the valve 500_1 such that the second cooling fluid in the second cooling line 400 that is the cooling line corresponding to the second reference frequency information passes via the first type electric part 100_1.

As another example, when the pulse width modulation switching frequency information acquired from the first type electric parts 100_3 illustrated in FIG. 2 is 8 KHz (that is, when the switching element included in the first type electric parts is IGBT), the controller may determine, among the first to third reference frequency information, the third reference frequency information (that is, information of a frequency band of less than 20 kHz) corresponding to the pulse width modulation switching frequency information of 8 KHz as specific reference frequency information, and may control the valve 500_3 such that the first cooling fluid in the first cooling line 300 that is the cooling line corresponding to the third reference frequency information passes via the first type electric part 100_3.

For reference, FIG. 2 illustrates a configuration of cooling the three first type electric parts 100_1, 100_2, and 100_3 by using any one of the two cooling lines, that is, the first cooling line 300 and the second cooling line 400, but this is a simple example for helping understanding, and the system 1000 for thermal management of electric parts according to the present disclosure is not limited to the example.

That is, the system 1000 for thermal management of electric parts of the present disclosure may include three or more cooling lines. For example, the system for thermal management of electric parts of the present disclosure may include three cooling lines, and then, the first to third valves 500_1, 500_2, and 500_3 may be four-way valves.

Meanwhile, the system 1000 for thermal management of electric parts of the present disclosure, as illustrated in FIG. 2, may further include the second type electric parts 200_1 and 200_2, via which the first cooling fluid in the first cooling line 300 passes.

For reference, unlike the above-described first type electric parts 100_1, 100_2, and 100_3, the second type electric parts 200_1 and 200_2 may be electric parts (for example, an air compressor, an air cooler, and a motor) that exhibit optimum efficiencies as temperature becomes lower regardless of the kinds thereof.

Accordingly, the controller may perform thermal management of the second type electric parts 200_1 and 200_2 through a scheme that is different from the thermal management scheme for the first type electric parts 100_1, 100_2, and 100_3 (the scheme of the cooling fluid in, among the first cooling line and the second cooling line, any one cooling line passing via the corresponding electric parts, by controlling the valves according to the kinds of the first type electric parts). For example, the controller may perform thermal management of the second type electric parts 200_1 and 200_2 through the first cooling line 300.

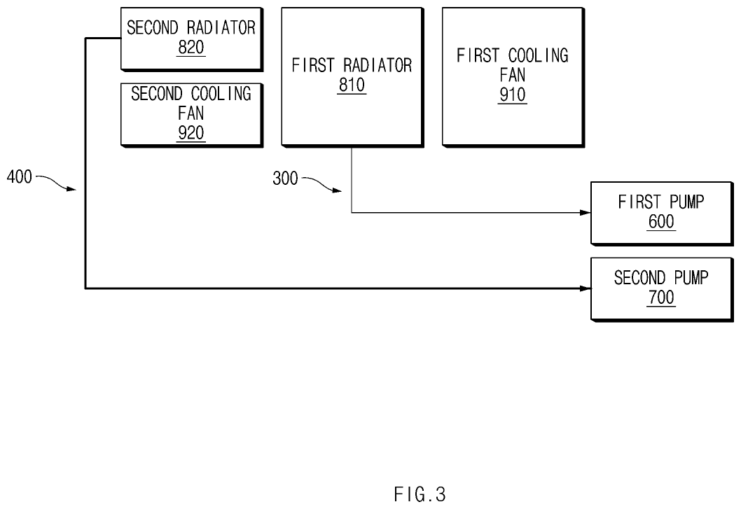

Meanwhile, the radiator 800 according to the system 1000 for thermal management of electric parts of the present disclosure, as illustrated in FIG. 3, may include a first radiator 810 that is configured to cool the first cooling fluid and a second radiator 820 that is configured to cool the second cooling fluid.

The first radiator 810 and the second radiator 820 may have various structures that are disposed in the first cooling line 300 and the second cooling line 400, respectively, to cool the first cooling fluid and the second cooling fluid, respectively, and the present disclosure is neither limited nor restricted by the kinds and structures of the first radiator 810 and the second radiator 820. The first radiator 810 and the second radiator 820 may be connected to a first reservoir (not illustrated) and a second reservoir (not illustrated), in which the first cooling fluid and the second cooling fluid are stored, respectively.

Furthermore, the cooling fan according to the system 1000 for thermal management of electric parts of the present disclosure, as illustrated in FIG. 3, may include a first cooling fan 910 that is configured to blow exterior air to the first radiator 810 and a second cooling fan 920 that is configured to blow exterior air to the second radiator 820.

Then, the controller may control the first cooling fan 910 and the first pump 600 on the first cooling line 300 with reference to an output value of the fuel cell stack (not illustrated), which is used for energy sources of the first type electric part and the second type electric part. For example, the controller may control the first cooling fan 910 and the first pump 600 such that a revolutions-per-minute (RPM) of the first cooling fan 910 and an RPM of the first pump 600 are proportional to the output value of the fuel cell stack.

Meanwhile, the controller may control the second cooling fan 920 and the second pump 700 on the second cooling line 400 in a scheme that is different from a control scheme of the first cooling fan 910 and the first pump 600 of the first cooling line 300.

As an example, when determining that a temperature of the second cooling fluid is a threshold temperature or more, the controller may control the second cooling fan 920 such that an RPM of the second cooling fan 920 is a first threshold RPM or more, and may control the second pump 700 such that an RPM of the second pump 700 is a second threshold RPM or more. Meanwhile, when determining that a temperature of the second cooling fluid is less than a threshold temperature, the controller may control the second cooling fan 920 and the second pump 700 such that the RPM of the second cooling fan 920 and the RPM of the second pump 700 are proportional to an output of the fuel cell stack, which interworks with the first type electric parts and the second type electric parts.

For example, when the switching element included in the first type electric parts is GaN, a temperature that exhibits an optimum efficiency may be about 25 degrees Celsius. When determining that a temperature of the second cooling fluid that is circulated in the second cooling line 400 that passes via the first type electric parts including GaN is a threshold temperature (for example, 25 degrees Celsius), the controller may control the second cooling fan 920 such that the RPM of the second cooling fan 920 is maximal and may control the second pump 700 such that the RPM of the second pump 700 is maximal. Through this, the second cooling fluid may be rapidly cooled to an optimum temperature for efficiently operating GaN. Meanwhile, when it is determined that the temperature of the second cooling fluid is less than a threshold temperature (for example, 25 degrees Celsius), the controller may control the second cooling fan 920 and the second pump 700 such that the RPM of the second cooling fan 920 and the RPM of the second pump 700 are proportional to the output value of the fuel cell stack.

For reference, although it has been described in the example that the temperature of GaN, which exhibits an optimum efficiency, and the threshold temperature are the same, this is a simple example for helping understanding and the present disclosure is neither limited nor restricted by the example. When a temperature, at which GaN exhibits an optimum efficiency, is assumed to be 25 degrees Celsius, the threshold temperature may be set to 23 degrees Celsius.

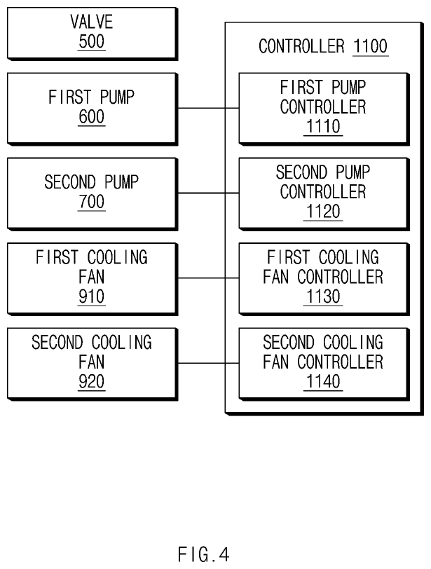

FIG. 4 is a functional block diagram of the system 1000 for thermal management of electric parts according to various embodiments of the present disclosure. The configuration illustrated in FIG. 4 may be a hardware device or a program (or an application) including instructions.

A controller 1100 may be a hardware device, such as a processor or a central processing unit (CPU), or a program that is implemented by a processor. The controller 1100 may be connected to various configurations of the system 1000 for thermal management of electric parts to perform an overall function of the system 1000 for thermal management of electric parts. In an embodiment, the controller 1100 may detect a breakdown of a valve 500. For example, the controller 1100 may detect a defect in an actuator or a gear of the valve 500 through a sensor. As another example, the controller 1100 may detect an inability of a controller area network (CAN) communication between the controller 1100 and the valve 500. Each configuration included in the controller 1100 may be implemented by individual devices (or programs) or may be implemented by one integrated module.

A first pump controller 1110, a second pump controller 1120, a first cooling fan controller 1130, and a second cooling fan controller 1140 may control operations of the first pump 600, the second pump 700, the first cooling fan 910, and the second cooling fan 920, respectively. For example, the second cooling fan controller 1140 may maximally secure an amount of wind by controlling the second cooling fan 920 such that the RPM of the second cooling fan 920 is a first threshold RPM or more, based on information corresponding to the first type electric parts, and the second pump controller 1120 may maximally secure a flow rate of the second cooling fluid by controlling the second pump 700 such that the RPM of the second pump 700 is a second threshold RPM or more, based on the information corresponding to the first type electric parts. Through this, the system 1000 for thermal management of electric parts may minimize the deterioration of a cooling performance of the second cooling fluid.

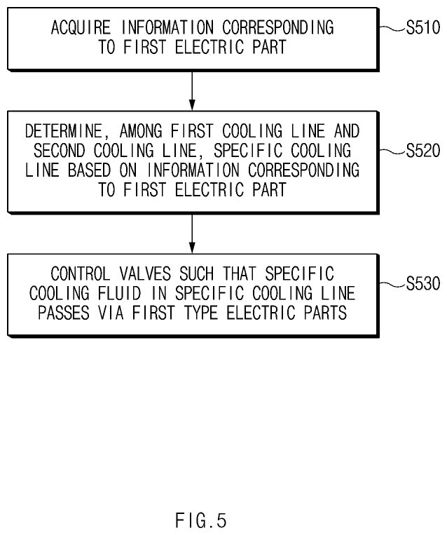

FIG. 5 is a flowchart of an operation of a system for the system 1000 for thermal management of electric parts according to an embodiment disclosed in the present disclosure. The operations of the flowchart of the operations illustrated below may be implemented by the system 1000 for thermal management of electric parts or a configuration (for example, the controller) included in the system 1000 for thermal management of electric parts.

Referring to FIG. 5, the thermal management method for electric parts may include an operation of acquiring information corresponding to a first type electric part (S510), an operation of determining, among a first cooling line, in which a first cooling fluid is circulated, and a second cooling line, in which a second cooling fluid is circulated, a specific cooling line, based on information corresponding to the first type electric part (S520), and an operation of controlling a valve such that a specific cooling fluid in the specific cooling line passes via the first type electric part (S530).

In operation S510, the controller 1100 may acquire information (for example, the pulse width modulation switching frequency information of the first type electric parts) corresponding to the first type electric parts from the first type electric parts.

Furthermore, in operation S520, the controller may determine, among the first cooling line, in which the first cooling fluid pumped by the first pump is circulated, and the second cooling line, in which the second cooling fluid pumped by the second pump is circulated, a specific cooling line, based on the information corresponding to the first type electric parts.

Furthermore, in operation S530, the controller may make the specific cooling line to pass via the first type electric parts by controlling the valves. Through this, the controller may cause the specific cooling fluid cooled by the radiator, to which the exterior air is blown by the cooling fan to be circulated in the specific cooling fan whereby the first type electric parts are operated at an optimum temperature.

The system for thermal management of electric parts disclosed in the embodiments of the present disclosure may efficiently perform thermal management of the electric parts by controlling the valves based on the information corresponding to the electric parts. Accordingly, electric power that is consumed for operations of the electric parts may be reduced.

The system for thermal management of electric parts disclosed in the embodiments of the present disclosure may prevent a situation, in which the fuel cell system is abruptly ended due to overheating of a specific electric part by efficiently performing thermal management of the electric parts. Accordingly, a durability of the fuel cell system may be enhanced.

In addition, various effects directly or indirectly recognized through the present disclosure may be provided.

Although it may have been described until now that all the components constituting the embodiments of the present disclosure are coupled to one or coupled to be operated, the present disclosure is not essentially limited to the embodiments. That is, without departing from the purpose of the present disclosure, all the components may be selectively coupled into one or more components to be operated.

Furthermore, because the terms, such as “comprising”, “including”, or “having” may mean that the corresponding component may be included unless there is a specially contradictory description, it should be construed that another component is not extruded but may be further included. In addition, unless defined otherwise, all terms used herein, including technical or scientific terms, have the same meanings as those generally understood by those skilled in the art to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

The above description is a simple exemplification of the technical spirits of the present disclosure, and the present disclosure may be variously corrected and modified by those skilled in the art to which the present disclosure pertains without departing from the essential features of the present disclosure. Accordingly, the embodiments disclosed in the present disclosure is not provided to limit the technical spirits the embodiments of the present disclosure but provided to describe the present disclosure, and the scope of the technical spirits of the present disclosure is not limited by the embodiments. Accordingly, the genuine technical scope of the present disclosure should be construed by the attached claims, and all the technical spirits within the equivalent ranges fall within the scope of the present disclosure.

What is claimed is:

1. A system for thermal management of electric parts, the system comprising:
a first cooling line, in which a first cooling fluid is circulated;
a second cooling line, in which a second cooling fluid is circulated;
a valve configured to selectively pass a first cooling fluid or a second cooling fluid via a first type electric part; and
a controller connected to the valve,
wherein the controller is configured to control the valve based on information corresponding to the first type electric part.

2. The system of claim 1, wherein when a pulse width modulation switching frequency information is acquired as the information corresponding to the first type electric part, the controller is further configured to control the valve based on pulse width modulation switching frequency information and reference frequency information.

3. The system of claim 2, wherein the reference frequency information includes first reference frequency information and second reference frequency information, and
wherein the controller is further configured to:
determine, among the first reference frequency information and the second reference frequency information, specific reference frequency information corresponding to the pulse width modulation switching frequency information; and
control the valve based on the specific reference frequency information.

4. The system of claim 1, further comprising:
a first pump disposed on the first cooling line and configured to pump the first cooling fluid;
a second pump disposed on the second cooling line and configured to pump the second cooling fluid; and
a radiator disposed on the first cooling line and the second cooling line and configured to cool the first cooling fluid and the second cooling fluid.

5. The system of claim 4, wherein the radiator includes:
a first radiator configured to cool the first cooling fluid; and
a second radiator configured to cool the second cooling fluid.

6. The system of claim 5, further comprising:
a cooling fan configured to blow exterior air to the radiator.

7. The system of claim 6, wherein the cooling fan includes:
a first cooling fan configured to blow the exterior air to the first radiator; and
a second cooling fan configured to blow the exterior air to the second radiator.

8. The system of claim 7, further comprising:
a second type electric part, via which the first cooling fluid in the first cooling line passes,
wherein the controller is further configured to control the valve based on information corresponding to the second type electric part.

9. The system of claim 8, wherein the controller is further configured to control the first cooling fan and the first pump such that a revolutions-per-minute (RPM) of the first cooling fan and an RPM of the first pump are proportional to an output value of a fuel cell stack, and
wherein the fuel cell stack is configured to interwork with the first type electric part and the second type electric part.

10. The system of claim 8, wherein the controller is further configured to:
control the second cooling fan such that a revolutions-per-minute (RPM) of the second cooling fan comprises a first threshold RPM or an RPM greater than the first threshold RPM; and
control the second pump such that an RPM of the second pump is a second threshold RPM or an RPM greater than the second threshold RPM when determining that a temperature of the second cooling fluid is a threshold temperature or a temperature higher than the threshold temperature.

11. The system of claim 8, wherein the controller is further configured to control the second cooling fan and the second pump such that a revolutions-per-minute (RPM) of the second cooling fan and an RPM of the second pump is proportional to an output value of a fuel cell stack, and
wherein the fuel cell stack is configured to interwork with the first type electric part and the second type electric part, when a temperature of the second cooling fluid is lower than a threshold value.

12. A method for thermal management of electric parts, the method comprising:
acquiring information corresponding to a first type electric part;
selecting a specific cooling line among a first cooling line in which a first cooling fluid is circulated, and a second cooling line in which a second cooling fluid is circulated, based on the information corresponding to the first type electric part; and
controlling a valve such that the cooling fluid in the selected specific cooling line passes via the first type electric part.

13. The method of claim 12, wherein the determining of the specific cooling line includes:
determining the specific cooling line based on pulse width modulation switching frequency information of the first type electric part, the pulse width modulation switching frequency information comprising information corresponding to the first type electric part and reference frequency information.

14. The method of claim 13, wherein the reference frequency information includes first reference frequency information and second reference frequency information, and
wherein, the method further comprises:
determining among the first reference frequency information and the second reference frequency information, specific reference frequency information corresponding to the pulse width modulation switching frequency information of the first type electric part; and
determining the specific cooling line based on the specific reference frequency information.

15. The method of claim 12, further comprising:
controlling a first cooling fan and a first pump such that a revolutions-per-minute (RPM) of the first cooling fan configured to blow exterior air to a first radiator that cools the first cooling fluid and an RPM of the first pump configured to pump the first cooling fluid are proportional to an output value of a fuel cell stack,
wherein the fuel cell stack is configured to interwork with the first type electric part and a second type electric part, via which the first cooling fluid passes.

16. The method of claim 12, further comprising:
controlling a second cooling fan such that an RPM of the second cooling fan configured to blow the exterior air to a second radiator that cools the second cooling fluid is a first threshold RPM or an RPM greater than the first threshold RPM; and
controlling a second pump such that an RPM of the second pump configured to pump the second cooling fluid is a second threshold RPM or an RPM greater than the second threshold RPM when determining that a temperature of the second cooling fluid is a threshold temperature or higher than the threshold temperature.

17. The method of claim 12, further comprising:
controlling a second cooling fan and the second pump such that an RPM of the second cooling fan configured to blow the exterior air to a second radiator that cools the second cooling fluid and an RPM of a second pump configured to pump the second cooling fluid are proportional to an output value of a fuel cell stack,
wherein the fuel cell stack is configured to interwork with the first type electric part, when determining that a temperature of the second cooling fluid is lower than a threshold temperature.

18. The system of claim 1, wherein the information corresponding to the first type electric part includes an optimal operation temperature for the first type electric part.

19. The system of claim 8, wherein the information corresponding to the second type electric part includes an optimal operation temperature for the second type electric part.
